(19) United States
(12) Patent Application Publication
(10) Pub. No.: US 2011/0297103 A1
(43) Pub. Date: Dec. 8, 2011

(54) PET BATHTUB

(75) Inventor: Lian-Tian Iou, Taipei Hsien (TW)

(73) Assignee: LI LAI DEN INDUSTRIAL CO., LTD.

(21) Appl. No.: 12/792,343

(22) Filed: Jun. 2, 2010

(51) Int. Cl. A01K 13/00

(52) U.S. Cl. 119/676

(57) ABSTRACT

A pet bathtub includes a bathtub body having a bathing chamber covered with a hinged cover, a drain pipe for carrying water away from the bathing chamber and an open entry through which the pet extends its head out of the bathing chamber, a water supply unit having a water intake pipe installed in the bathtub body and connected to an external water source and water spray tubes arranged in the cover for ejecting water from the water intake pipe into the bathing chamber, and an air supply unit mounted in the bathtub body and having an air delivery tube with an air nozzle for ejecting forced air to dry the pet.

### BACKGROUND OF THE INVENTION

1. Field of the Invention

The present invention relates to pet bathing equipment and more particularly, to a pet bathtub, which enables the pet to receive all the bathing procedures in the bathing chamber, saving much bathing time and labor and avoiding splashing.

2. Description of the Related Art

Following change of living habits and improvement of living standards, people may raise animals as pets for companionship and enjoyment, in addition to the concerns of eating, clothes, living, transportation and entertainment. The most popular pets are dogs, cats and birds that are noted for their loyal or playful characteristics. However, pets will be covered with a bad smell, dirt and dusts in daily life and must be washed and cleaned regularly. After bathing in a bathtub or cleaning of a pet with a cleansing agent, the pet must be moved to another place and dried by using an air blower or air dryer. When bathing the pet or moving the pet out of the bathtub, water may be shaken out of the pet's body. At this time, the water drops that are shaken out of the pet's body will fall to the ground and the pet owner. After cleaning of the pet, the pet owner may have to clean the floor.

Further, a pet owner may send his or her pet to a pet shop to receive a grooming service. When grooming a pet, the pet is brushed and cleaned in a pet bathtub, and then carried to a worktable for drying and posterior grooming works. When carrying the pet from the pet bathtub to the worktable, the pet may shake off water, causing water droplets to go off in all directions, thereby wetting the surroundings and the worker.

Therefore, the conventional pet grooming method has drawbacks as follows:
1. When a pet is carried away from the bathtub for drying after washing, water drops will fall from the pet's body to the floor to wet the surroundings and the pet owner or the worker.
2. When cleaning a pet in a pet bathtub or drying the pet on a worktable outside the pet bathtub after bathing, water droplets may go off from the body of the pet in all directions, wetting the surroundings and the worker.

### SUMMARY OF THE INVENTION

The present invention has been accomplished under the circumstances in view. It is one object of the present invention to provide pet bathtub, which enables the pet to receive all the bathing procedures in the bathing chamber, such as cleaning, brush-washing, rinsing, dipping, cold air drying and/or hot air drying, saving much bathing time and labor and avoiding splashing.

To achieve this and other objects of the present invention, the pet bathtub comprises a bathtub body having a bathing chamber covered with a hinged cover, a drain pipe for carrying water away from the bathing chamber and an open entry through which the pet extends its head out of the bathing chamber, a water supply unit having a water intake pipe installed in the bathtub body and connected to an external water source and water spray tubes arranged in the cover for ejecting water from the water intake pipe into the bathing chamber, and an air supply unit having an air delivery tube with an air nozzle for ejecting forced air to dry the pet.

Further, two pneumatic cylinders are connected between two opposite lateral sides of the bathing chamber and the inner wall of the cover for buffering opening/closing movement of the cover relative to the bathtub body, avoiding damage and preventing accidental injury to the pet.

Further, the bathtub body defines a compartment in one end thereof outside the bathing chamber for accommodating the water supply unit. Further, the water supply unit comprises a control switch disposed outside the bathtub body for operation by the user to turn on/off the water intake pipe.

Further, a micro-bubble generator or milky SPA machine can be used with the pet bathtub to supply micro bubbles or a milky fluid to the bathing chamber for massaging the pet and removing germs, vermin and bad smell from the pet, or for enabling the pet to enjoy a milky spa.

### BRIEF DESCRIPTION OF THE DRAWINGS

FIG. 1 is a perspective view of a pet bathtub in accordance with the present invention.

FIG. 2 is a sectional side view of the pet bathtub in accordance with the present invention.

FIG. 3 is a schematic sectional side view of the present invention, showing water ejected out of the jet nozzles of the water spray tubes into the bathing chamber.

FIG. 4 is another sectional side view of the pet bathtub in accordance with the present invention.

FIG. 5 is a schematic applied view of the present invention.

### DETAILED DESCRIPTION OF THE PREFERRED EMBODIMENT

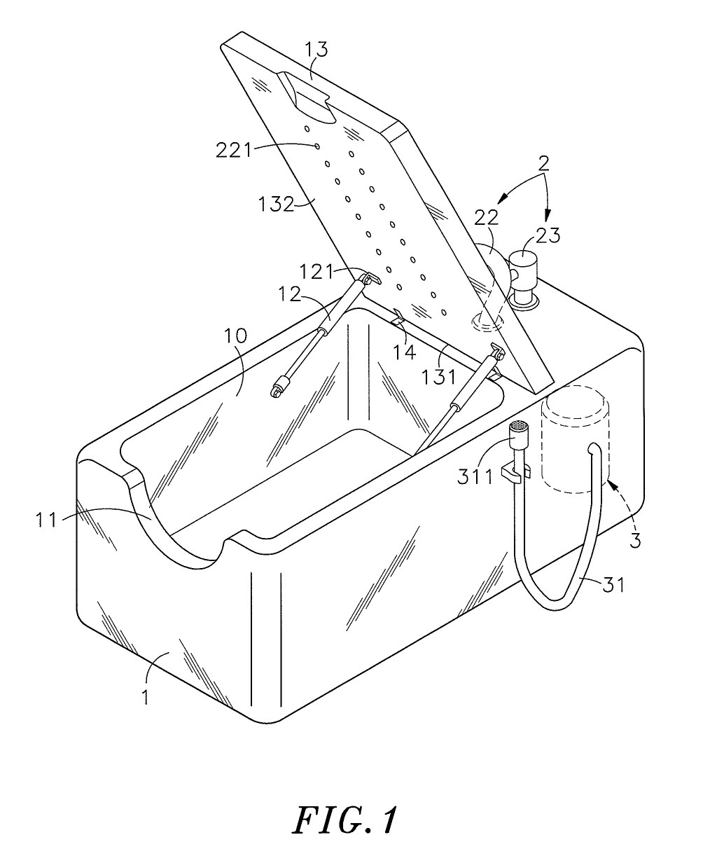

Referring to FIGS. 1˜3, a pet bathtub in accordance with the present invention is shown comprising a bathtub body 1 that has a bathing chamber 10 defined therein, a drain pipe 101 extended from the bottom side thereof for carrying water away from the bathing chamber 10 and an open entry 11 located on one end thereof through which the pet bathing in the bathing chamber 10 can extend the head to the outside of the bathtub body 1, a cover 13 for closing the top open side of the bathing chamber 10, connection means 14 connected between one end 131 of the cover 13 and one end of the bathing chamber 10 opposite to the open entry 11 for enabling the cover 13 to be turned relative to the bathtub body 1 to close or open the bathing chamber 10, two pneumatic cylinders 12 respectively mounted on two opposite lateral sides of the bathing chamber 10 and having a respective coupling portion 121 located on one end thereof and pivotally connected to the inner wall 132 of the cover 13 for enabling the cover 13 to be closed or opened smoothly, each pneumatic cylinder 12, a compartment 15 defined in the bathtub body 1 adjacent to one end of the bathing chamber 10 remote from the open entry 11, a water supply unit 2 installed in the bathtub body 1 for providing water for bathing and an air supply unit 3 installed in the bathtub body 1 for providing hot/cold air for drying purpose.

The aforesaid water supply unit 2 comprises a water intake pipe 21 connected to an external water source (such as, water tank, water faucet, water pump, etc.), at least one, for example, a number of water spray tubes 22 connected to the water intake pipe 21, each water spray tube 22 having a plurality of jet nozzles 221 through which water is ejected from the water intake pipe 21 out of the water spray tubes 22 into the bathing chamber 10, and a control switch 23 for controlling the flow rate of water passing from the water intake pipe 21 through the water spray tubes 22.

The aforesaid air supply unit 3 can be an air dryer, hot/warm/cold air blower, electric forced air heater or the like adapted for providing cold/hot air, comprising an air supply tube 31 and an air nozzle 311 at the end of the air supply tube 31.

The water intake pipe 21 of the water supply unit 2 and the air generating device 31 of the air supply unit 3 are mounted in the compartment 15 of the bathtub body 1. The water intake pipe 21 of the water supply unit 2 extends out of one side, for example, the bottom side of the compartment 15 of the bathtub body 1 and is then connected to an external water source. The water spray tubes 22 of water supply unit 2 is arranged in the cover 13 in such a manner that the jet nozzles 221 of the water spray tubes 22 extends out of the inner wall 132 of the cover 13 for ejecting water toward the inside of the bathing chamber 10. Further, the control switch 23 that is connected with the water intake pipe 21 is installed in the top wall of the bathtub body 1 outside the bathing chamber 10. The air supply unit 3 can be mounted in (or outside) the bathtub body 1.

The aforesaid connection means 14 can be formed of hinges or swivel connectors connected between one end 131 of the cover 13 and one end of the bathing chamber 10 opposite to the open entry 11 for enabling the cover 13 to be turned relative to the bathtub body 1 to close or open the bathing chamber 10. Further, the inner wall 132 of the cover 13 around its free end is configured (for example, notched) to facilitate positioning of the pet's neck in the open entry 11 without causing stress.

The external water source to which the water intake pipe 21 of the water supply unit 2 is connected can be a water pump, water reservoir, water faucet of home water supply system, micro-bubble generator or milky SPA machine.

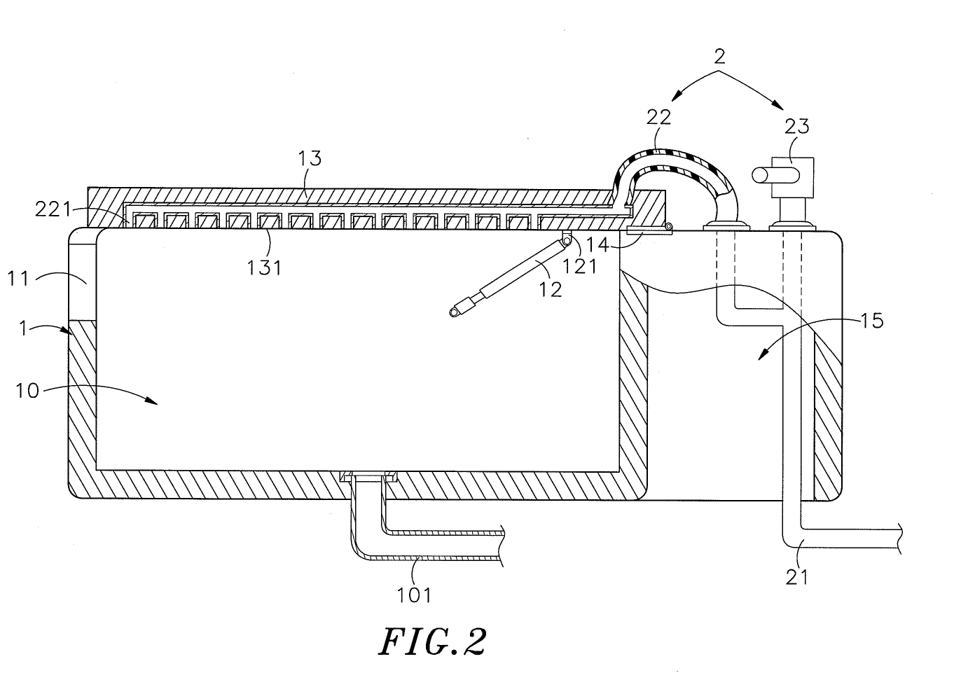

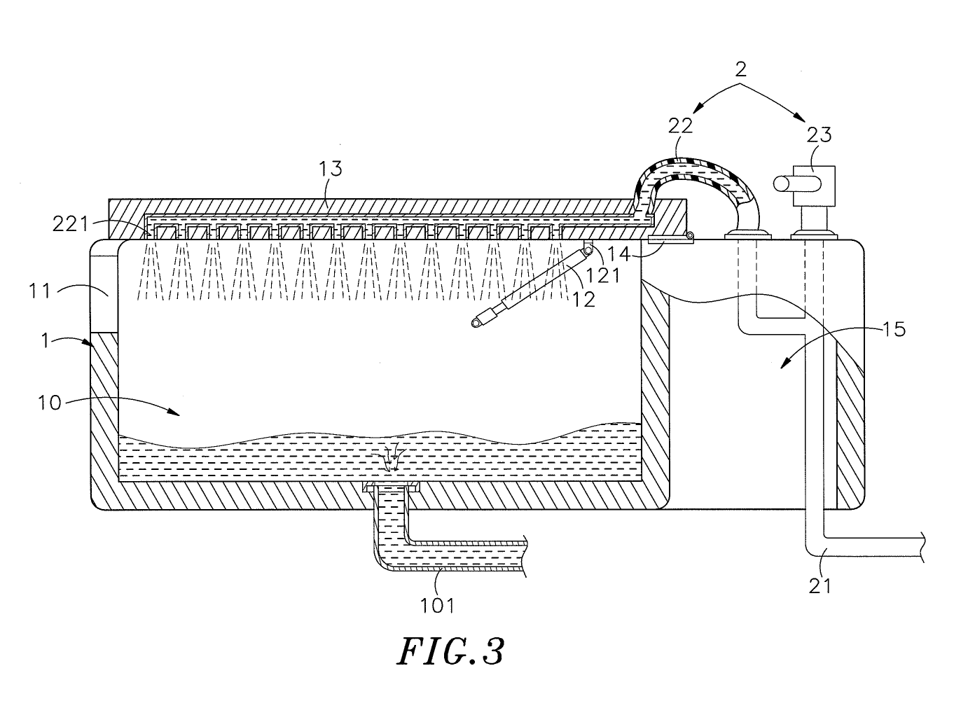

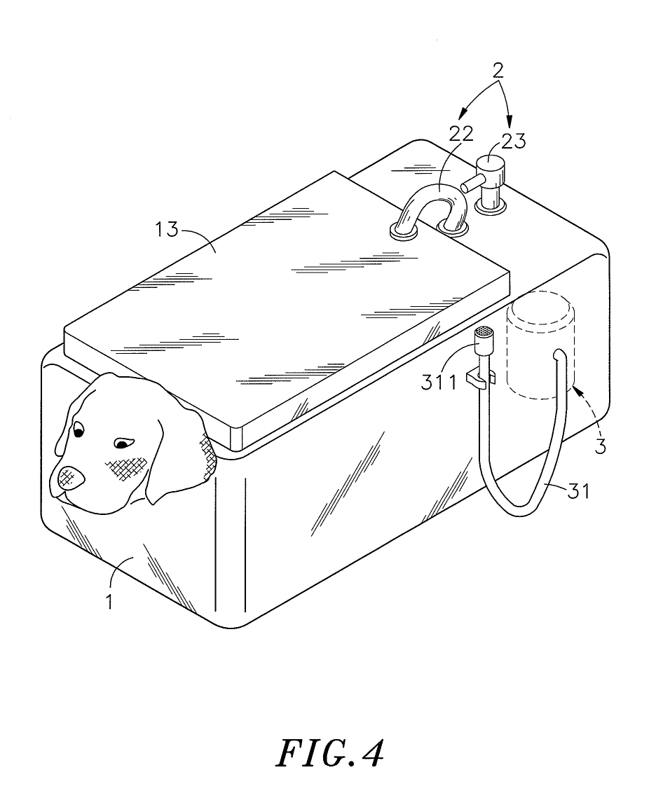

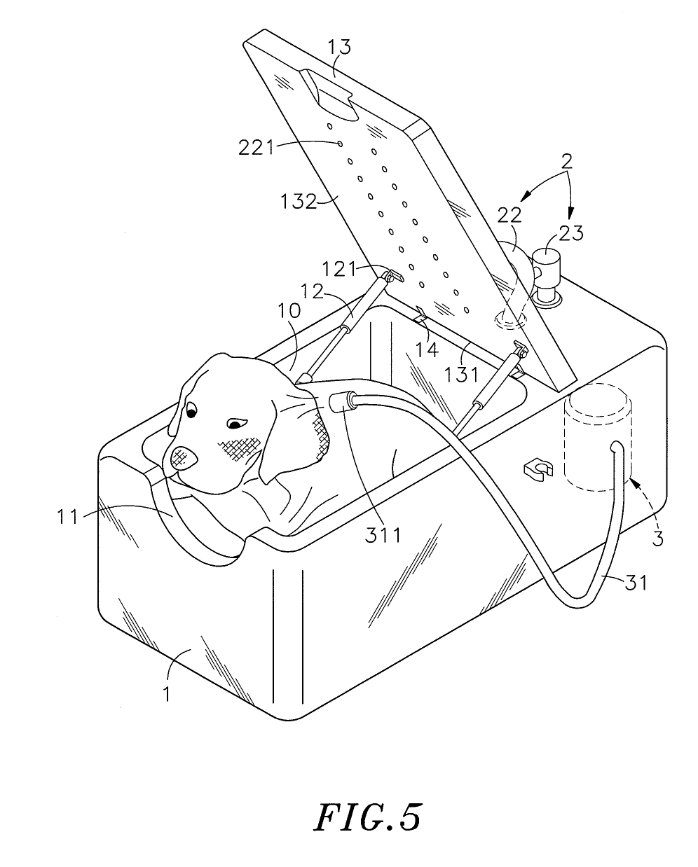

Referring to FIGS. 4 and 5 and FIGS. 2 and 3 again, when bathing a pet, put the pet in the bathing chamber 10 for receiving a series of bathing procedures, such as cleaning, brush-washing, rinsing, dipping, cold air drying and/or hot air drying. Further, the height, width and length of the bathing chamber 10 and the bathtub body 1 can be enlarged or reduced to fit big pets or small pets.

After the bathing chamber 10 has been filled with a proper amount of water, put the pet in the bathing chamber, a micro-bubble generator can be operated to supply micro-bubbles to water circulating through the bathing chamber 10 (a water circulating system may be installed in the bathtub body 1 to circulate water through the bathing chamber 10) for massaging the pet and removing germs, vermin and bad smell from the pet. Alternatively, a milky SPA machine may be used and connected to the water intake pipe 21 of the water supply unit 2 for enabling the pet to enjoy a milky spa.

Further, when a pet is put in the bathing chamber 10, the pet's neck is kept in the open entry 11 for enabling the pet's head to extend out of the bathtub body 1. Thus, the pet can be washed and cleaned with a brush. After washing, the cover 13 is turned downwards to close the bathing chamber 10 and to hold the pet's body in the bathing chamber 10 without causing stress. At this time, the user can operate the control switch 23 of the water supply unit 2 to let water flow out of the water intake pipe 21 of the water supply unit 2 into the water spray tubes 22 in the cover 13 so that water is ejected out of the jet nozzles 221 of the water spray tubes 22 toward the pet's body to remove cleansing agent and impurities from the pet's body. At the same time, dirty water is carried away from the bathing chamber 10 through the drain pipe 101. After cleaning, the bathing chamber 10 can be filled up with water for enabling the pet to be dipped in water. Because the pet's body is kept in the bathing chamber 10 that is covered by the cover 13, water will not fly out of the bathtub body 1. After cleaning and dipping, the control switch 23 of the water supply unit 2 is operated to turn off the water intake pipe 21, and the air supply unit 3 is operated to turn on the air generating device 31 is operated to provide hot, warm or cold air through the air delivery tube 31 and the air nozzle 311 toward the pet's body in the bathing chamber 10 to dry the pet's body. After drying, the pet is taken out of the bathing chamber 10. Thus, bathing the pet does not wet the surroundings or the worker.

Further, as stated above, the two pneumatic cylinders 12 are connected between the two opposite lateral sidewalls of the bathing chamber 10 and the inner wall 132 of the cover 13 in a parallel manner to smoothen opening/closing action of the cover 13, avoiding damage and preventing accidental injury to the pet.

Further, when a pet is put in the bathing chamber 10 of the bathtub body 1, the pet can receive a series of bathing procedures including cleaning, brush-washing, rinsing, dipping, cold air drying and/or hot air drying, saving much bathing time and labor. Further, because the pet's body is kept in the bathing chamber 10 that is covered by the cover 13, the invention prevents splashing of water from the bathtub body 1. Thus, the user can clean the pet conveniently and efficiently while keeping the surroundings clean.

As stated above, the invention has the cover 13 hinged to the bathtub body 1 for closing the bathing chamber 10 and the water spray tubes 22 arranged in the cover 13 and the air delivery tube 31 of the air supply unit 3 arranged outside the bathtub body 1 so that water and warm/cold air can be ejected out of the jet nozzles 221 or the air nozzle 311 toward the pet in the bathing chamber 10 from different sides to clean or dry the pet.

In conclusion, the invention provides a pet bathtub, which has the following advantages and features:

1. After washer or dipping in the bathing chamber 10 of the bathtub body 1, the pet can be directly dried in the bathing chamber 10, avoiding splashing and maintaining surroundings clean.

2. When the pet is washing, showering, rinsing or dipping in the bathing chamber 10, the cover 13 prevents splashing of water from the bathing chamber 10, keeping surroundings and the worker clean and dry.

3. A pet can receive a series of bathing procedures including washing, rinsing and drying, saving much bathing time and labor.

4. A micro-bubble generator or milky SPA machine can be used with the pet bathtub to supply micro bubbles or a milky fluid to the bathing chamber 10 for massaging the pet and removing germs, vermin and bad smell from the pet or for enabling the pet to enjoy a milky spa.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A pet bathtub, comprising:
a bathtub body, said bathtub body comprising a bathing chamber, a drain pipe extended from a bottom side thereof for carrying water away from said bathing chamber, an open entry located on one end of said bathing chamber for enabling the pet bathing in said bathing chamber to extend the head out of said bathing chamber and a compartment defined therein adjacent to one end of said bathing chamber remote from said open entry; and
a cover connected to one end of said bathtub body remote from said open entry for covering said bathing chamber for allowing the pet bathing in said bathing chamber to extend the head out of said bathing chamber.

2. The pet bathtub as claimed in claim 1, further comprising hinge means connected between one end of said cover and one end of said bathtub body remote from said open entry for enabling said cover to be turned relative to said bathtub body to close/open said bathing chamber.

3. The pet bathtub as claimed in claim 2, further comprising two pneumatic cylinders connected between two opposite lateral sides of said bathing chamber and an inner wall of said cover for buffering opening/closing movement of said cover relative to said bathtub body.

4. The pet bathtub as claimed in claim 1, as claimed in claim 1, further comprising a water supply unit, said water supply unit comprising a water intake pipe installed in said bathtub body and connected to an external water source and at least one water spray tube, each said water spray tube having a plurality of jet nozzles for ejecting water out of said water spray tubes into said bathing chamber when said cover closes said bathing chamber.

5. The pet bathtub as claimed in claim 1, as claimed in claim 4, wherein said external water source is a water pump, water reservoir, water faucet of home water supply system; said water supply unit further comprises a control switch mounted on said bathtub outside said bathing chamber for turning on/off said water intake pipe.

6. The pet bathtub as claimed in claim 1, as claimed in claim 4, wherein said at least one water spray tube is arranged in said cover, each said water spray tube having the jet nozzles thereof extending out of an inner wall of said cover for ejecting water from said water intake pipe toward the inside of said bathing chamber when said cover closes said bathing chamber.

7. The pet bathtub as claimed in claim 1, as claimed in claim 1, further comprising an air supply unit selected from a group consisting of air dryer, hot/warm/cold air blower and electric forced air heater and mounted in said bathtub both.

8. The pet bathtub as claimed in claim 1, as claimed in claim 1, wherein said air supply unit comprises an air supply tube having an air nozzle at a distal end thereof for air output.
